(19) United States
(12) Patent Application Publication
(10) Pub. No.: US 2025/0069785 A1
(43) Pub. Date: Feb. 27, 2025

(54) NEODYMIUM-IRON-BORON MAGNET MATERIAL, PREPARATION THEREFOR, AND APPLICATION THEREOF

(71) Applicant: FUJIAN GOLDEN DRAGON RARE-EARTH Co., Ltd., Fujian (CN)

(72) Inventors: Weiguo MOU, Fujian (CN); Chen WANG, Fujian (CN); Zhigao HUANG, Fujian (CN); Gang FU, Fujian (CN); Deqin XU, Fujian (CN)

(73) Assignee: FUJIAN GOLDEN DRAGON RARE-EARTH Co., Ltd., Fujian (CN)

(21) Appl. No.: 18/725,982

(22) PCT Filed: Nov. 4, 2022
(86) PCT No.: PCT/CN2022/129741

§ 371 Date: Jul. 1, 2024

(30) Foreign Application Priority Data
Apr. 29, 2022 (CN) 202210475096.1

(51) Int. Cl. H01F 1/057; C22C 38/00; C22C 38/06; C22C 38/10; C22C 38/14; C22C 38/16

(52) U.S. Cl. CPC H01F 1/0577; C22C 38/002; C22C 38/005; C22C 38/06; C22C 38/10; C22C 38/14; C22C 38/16; C22C 2202/02

(57) ABSTRACT

The invention discloses a neodymium-iron-boron magnet material, a preparation method, and use thereof. The neodymium-iron-boron magnet material comprises following components of: R: 28.00-32.00 wt %, wherein the R is a rare earth element; Al: 0.00-1.00 wt %; Cu: 0.12-0.50 wt %; B: 0.85-1.10 wt %; and a balance of Fe, wherein wt % refers to a weight percentage of respective elements in the neodymium-iron-boron magnet material; a volume percentage of a Nd—O phase having a FCC type crystal structure in an intergranular triangular zone of the neodymium-iron-boron magnet material in a grain boundary phase of the neodymium-iron-boron magnet material is equal to or less than 20%. By reducing the proportion of the Nd—O phase having the FCC type crystal structure, the present invention enhances the demagnetizing coupling ability of the grain boundary phase and improves the consistency of the intrinsic coercivity of the magnet.

### FIELD OF THE INVENTION

The invention relates to a neodymium-iron-boron magnet material, a preparation method, and use thereof.

### BACKGROUND OF THE INVENTION

Permanent magnetic materials were developed as key materials to support electronic devices. R-T-B series permanent magnet materials are known to have the highest performance among permanent magnets and are used in voice coil motors for hard disk drives, motors for electric vehicles, motors for industrial equipment, etc.

At present, the intrinsic coercivity of neodymium-iron-boron magnets without heavy rare earth additions when Br is 14.0 kGs is only about 18.3 kOe, which is less than ⅓ of the theoretical intrinsic coercivity of NdFeB. Therefore, how to further improve the intrinsic coercivity of R-T-B series permanent magnet materials without using heavy rare earths or using less heavy rare earths is currently a research direction in this field.

The prior art discloses methods of increasing coercivity by reducing the particle size of magnetic powder. For example, CN 111968813 A discloses that no dehydrogenation treatment is performed after the hydrogen decrepitation process, and the grain boundary phase of the obtained NdFeB-based magnetic powder is a rare earth-rich phase with a low oxygen content, which is beneficial to reducing the loss of rare earth elements in the sintered magnet and inhibiting the grain growing during the sintering process, thereby improving the organizational structure of the sintered magnet and improving the magnetic and mechanical properties of the sintered magnet. However, the extent to which this method can improve the intrinsic coercivity is limited, wherein when Br is 14.6 kGs, the intrinsic coercivity is only about 14.42 kOe. In addition, there is a defect that microcracks are easily formed inside the magnet during the sintering dehydrogenation process, resulting in a decrease in the bending strength of the magnet.

Therefore, how to further optimize the formula of magnet materials to obtain neodymium-iron-boron magnet materials with better magnetic properties is an urgent technical problem that needs to be solved.

### SUMMARY OF THE INVENTION

The technical problem to be solved by the present invention is to overcome the defects in the existing technology that rely on heavy rare earths to improve the intrinsic coercivity of neodymium-iron-boron magnets, and provide a neodymium-iron-boron magnet material and its preparation method and use. According to the present invention, by controlling the compositions and manufacturing process, the formation of the Nd—O phase having an FCC type crystal structure is suppressed, and its volume percentage in the grain boundary phase is controlled within 20%. Thus, the obstruction of the Nd—O phase having the FCC type crystal structure with a higher melting point to the fluidity of the Nd-rich phase during the aging process is reduced, which is conducive to the formation of a continuous and uniform intergranular Nd-rich phase, thereby enhancing the demagnetizing coupling ability of the grain boundary phase and improving the consistency of the intrinsic coercivity of the magnet.

During the research and development process, the inventor creatively discovered that the Nd—O phase having a FCC type crystal structure in the neodymium-iron-boron magnet material is not conducive to the formation of a continuous and uniform intergranular Nd-rich phase, and additionally, it further consumes Nd in the magnet and forms agglomerates in the intergranular triangular zone, resulting in an increase in the Fe content in the intergranular phase, and further causing the alloying between Fe and the main phase to intensify, resulting in a decrease in the proportion of the main phase and a decrease in magnet performance.

The present invention mainly solves the above technical problems through the following technical solutions.

The invention provides a neodymium-iron-boron magnet material, comprising following components of:
R: 28.00-32.00 wt %, wherein the R is a rare earth element;
Al: 0.00-1.00 wt %;
Cu: 0.12-0.50 wt %;
B: 0.85-1.10 wt %; and
a balance of Fe, wherein wt % refers to a weight percentage of respective elements in the neodymium-iron-boron magnet material;
a volume percentage of a Nd—O phase having a FCC type crystal structure in an intergranular triangular zone of the neodymium-iron-boron magnet material in a grain boundary phase of the neodymium-iron-boron magnet material is equal to or less than 20%; and
the grain boundary phase of the neodymium-iron-boron magnet material comprises a two-granule grain boundary phase and the intergranular triangular zone.

In the invention, the R can have a content of 28.50-32.00 wt %, such as 28.65 wt %, 29.20 wt %, 29.50 wt %, 29.51 wt %, 30.15 wt %, 30.20 wt %, 30.30 wt %, 31.31 wt % or 32.00 wt %, wherein wt % refers to a weight percentage of R in the neodymium-iron-boron magnet material.

In the present invention, the R may be a conventional rare earth element in the art, and may generally include a light rare earth element and/or a heavy rare earth element.

Wherein, the light rare earth element can be Pr and/or Nd.

Wherein, the light rare earth element can have a content of 28.50-32.00 wt %, such as 28.50 wt %, 29.00 wt %, 29.50 wt %, 29.51 wt %, 30.00 wt %, 30.20 wt %, 30.51 wt % or 32.00 wt %, wherein wt % refers to a weight percentage of the light rare earth element in the neodymium-iron-boron magnet material.

When the R comprises Pr, the Pr can have a content of 5.00-10.00 wt %, such as 5.40 wt %, 6.50 wt %, 7.38 wt %, 7.50 wt %, 7.63 wt % or 8.00 wt %, wherein wt % refers to a weight percentage of Pr in the neodymium-iron-boron magnet material.

When the R comprises Nd, the Nd can have a content of 20.00-32.00 wt %, such as 22.00 wt %, 22.13 wt %, 22.50 wt %, 22.88 wt %, 23.50 wt %, 24.60 wt %, 28.50 wt %, 29.00 wt %, 29.50 wt %, 30.20 wt % or 32.00 wt %, wherein wt % refers to a weight percentage of Nd in the neodymium-iron-boron magnet material.

Wherein, the heavy rare earth element can be Dy and/or Tb.

The heavy rare earth element can have a content of 0.10-3.00 wt %, such as 0.15 wt %, 0.20 wt %, 0.30 wt % or 0.80 wt %, wherein wt % refers to a weight percentage of the heavy rare earth element in the neodymium-iron-boron magnet material.

When the R comprises Dy, the Dy can have a content of 0.10-3.00 wt %, such as 0.15-1.00 wt %, also such as 0.15 wt %, 0.20 wt %, 0.30 wt % or 0.80 wt %, wherein wt % refers to a weight percentage of Dy in the neodymium-iron-boron magnet material.

In the invention, the Al can have a content of 0.00-0.80 wt %, such as 0.05-0.80 wt %, also such as 0.05 wt %, 0.10 wt %, 0.30 wt %, 0.45 wt %, 0.50 wt % or 0.80 wt %, wherein wt % refers to a weight percentage of the Al in the neodymium-iron-boron magnet material.

In the invention, the Cu preferably have a content of 0.13-0.50 wt %, such as 0.15 wt %, 0.20 wt %, 0.30 wt %, 0.35 wt % or 0.40 wt %, wherein wt % refers to a weight percentage of the Cu in the neodymium-iron-boron magnet material.

In the invention, the B can have a content of 0.86-1.00 wt %, such as 0.86 wt %, 0.92 wt %, 0.94 wt %, 0.96 wt %, 0.98 wt % or 1.00 wt %, wherein wt % refers to a weight percentage of the B in the neodymium-iron-boron magnet material.

In the invention, the Fe can have a content of 64.50-69.00 wt %, such as 64.72 wt %, 66.24 wt %, 66.33 wt %, 67.06 wt %, 67.14 wt %, 67.18 wt %, 67.52 wt %, 67.98 wt %, 68.13 wt %, 68.23 wt % or 68.27 wt %, wherein wt % refers to a weight percentage of the Fe in the neodymium-iron-boron magnet material.

In the invention, the neodymium-iron-boron magnet material further comprises one or more of Ga, Co, Zr and Ti.

When the neodymium-iron-boron magnet material further comprises Ga, the Ga can have a content of 0.00-1.00 wt %, excluding 0, such as 0.05-0.80 wt %, also such as 0.15 wt %, 0.20 wt %, 0.40 wt %, 0.50 wt % or 0.60 wt %, wherein wt % refers to a weight percentage of Ga in the neodymium-iron-boron magnet material.

When the neodymium-iron-boron magnet material further comprises Co, the Co can have a content of 0.20-2.00 wt %, such as 0.30 wt %, 0.40 wt %, 0.50 wt %, 0.80 wt %, 1.00 wt % or 1.50 wt %, wherein wt % refers to a weight percentage of Co in the neodymium-iron-boron magnet material.

When the neodymium-iron-boron magnet material further comprises Zr, the Zr can have a content of 0.05-0.60 wt %, such as 0.08 wt %, 0.10 wt %, 0.15 wt %, 0.30 wt %, 0.40 wt % or 0.50 wt %, wherein wt % refers to a weight percentage of Zr in the neodymium-iron-boron magnet material.

When the neodymium-iron-boron magnet material further comprises Ti, the Ti can have a content of 0.05-0.40 wt %, such as 0.05 wt % or 0.08 wt %, wherein wt % refers to a weight percentage of Ti in the neodymium-iron-boron magnet material.

In a preferable embodiment of the invention, the neodymium-iron-boron magnet material comprises following components of:
R: 28.00-32.00 wt %, wherein the R is a rare earth element;
Cu: 0.12-0.50 wt %;
B: 0.85-1.10 wt %;
Co: 0.20-2.00 wt %;
Ga: 0.05-0.80 wt %;
Zr: 0.05-0.60 wt %; and
a balance of Fe.

In a preferable embodiment of the invention, the neodymium-iron-boron magnet material comprises following components of:
Nd: 22.00-25.00 wt %;
Pr: 5.00-10.00 wt %;
RH: 0.10-1.00 wt %, wherein the RH comprises Dy and/or Tb;
Cu: 0.12-0.50 wt %;
B: 0.85-1.10 wt %;
Co: 0.20-2.00 wt %;
Ga: 0.15-0.60 wt %;
Zr: 0.05-0.50 wt %; and
a balance of Fe.

In a preferable embodiment of the invention, the neodymium-iron-boron magnet material comprises following components of:
R: 28.00-32.00 wt %, wherein the R is a rare earth element;
Cu: 0.12-0.50 wt %;
B: 0.85-1.10 wt %;
Al: 0.05-0.80 wt %;
Co: 0.20-2.00 wt %;
Ga: 0.05-0.80 wt %;
Zr: 0.05-0.60 wt %; and
a balance of Fe.

In a preferable embodiment of the invention, the neodymium-iron-boron magnet material comprises following components of:
Nd: 22.00-32.00 wt %;
Pr: 5.00-10.00 wt %;
RH: 0.10-1.00 wt %; wherein the RH comprises Dy and/or Tb;
Cu: 0.12-0.50 wt %;
B: 0.85-1.10 wt %;
Al: 0.05-0.80 wt %;
Co: 0.20-2.00 wt %;
Ga: 0.05-0.80 wt %;
Zr: 0.05-0.60 wt %;
Ti: 0.05-0.40 wt %; and
a balance of Fe.

In a preferable embodiment of the invention, the neodymium-iron-boron magnet material consists of any of the following formulas:

| | Ingredients/wt % | | | | | | | | | | |
|---|---|---|---|---|---|---|---|---|---|---|---|
| No. | Nd | Pr | Dy | Al | Cu | Ga | Co | Zr | Ti | B | Fe |
| Formula 1 | 29.50 | / | / | 0.05 | 0.15 | 0.15 | 0.80 | 0.10 | / | 0.98 | Balance |
| Formula 2 | 22.13 | 7.38 | / | 0.05 | 0.15 | 0.15 | 0.80 | 0.10 | 0.05 | 0.96 | Balance |
| Formula 3 | 22.88 | 7.63 | 0.80 | 0.45 | 0.15 | 0.15 | 0.50 | 0.15 | / | 0.96 | Balance |
| Formula 4 | 32.00 | / | / | 0.80 | 0.15 | 0.15 | 1.0 | 0.10 | 0.08 | 1.00 | Balance |
| Formula 5 | 29.00 | / | 0.20 | 0.10 | 0.40 | 0.20 | 1.5 | 0.08 | 0.08 | 0.92 | Balance |
| Formula 6 | 28.50 | / | 0.15 | 0.10 | 0.40 | 0.20 | 1.5 | 0.08 | 0.08 | 0.86 | Balance |
| Formula 7 | 22.5 | 7.5 | 0.15 | 0.30 | 0.35 | 0.4 | 0.4 | 0.30 | / | 0.92 | Balance |
| Formula 8 | 30.2 | / | / | 0.50 | 0.20 | 0.6 | 0.8 | 0.50 | / | 0.96 | Balance |
| Formula 9 | 22.00 | 8.00 | 0.15 | / | 0.20 | 0.15 | 0.30 | 0.30 | / | 0.92 | Balance |
| Formula 10 | 23.50 | 6.50 | 0.30 | / | 0.30 | 0.40 | 0.50 | 0.40 | / | 0.96 | Balance |
| Formula 11 | 24.60 | 5.40 | 0.20 | / | 0.40 | 0.50 | 0.40 | 0.50 | / | 0.94 | Balance |

In the invention, the volume percentage of a Nd—O phase having a FCC type crystal structure in a grain boundary phase of the neodymium-iron-boron magnet material is preferably ≤15.0%, such as 1.5%, 1.6%, 1.7%, 2.3%, 2.3%, 3.4%, 8.9%, 9.5%, 10.0%, 12.0% or 15.0%.

In the present invention, the grain boundary phase of the neodymium-iron-boron magnet material generally further contains an Nd-rich phase.

Wherein, the volume percentage of the Nd-rich phase to the grain boundary phase of the neodymium-iron-boron magnet material is preferably 9.0-15.0%, such as 9.2%, 9.4%, 9.5%, 9.6%, 10.2%, 10.5%, 10.8% or 14.2%.

In the invention, the neodymium-iron-boron magnet material can have an oxygen content≤600 ppm, such as 408 ppm, 415 ppm, 448 ppm, 453 ppm, 455 ppm, 456 ppm, 463 ppm, 468 ppm, 476 ppm or 487 ppm.

In the present invention, the neodymium-iron-boron magnet material can have a main phase average grain size of 7.0-8.0 μm, such as 7.0 μm, 7.1 μm, 7.2 μm, 7.3 μm, 7.5 μm or 7.6 μm.

The invention further provides a preparation method for a neodymium-iron-boron magnet material, comprising following steps of subjecting a raw material composition for the neodymium-iron-boron magnet material to smelting, casting, pulverization, shaping, sintering and aging treatments in turn, wherein:
(1) the raw material composition for the neodymium-iron-boron magnet material comprises following components of:
R: 28.00-32.00 wt %, wherein the R is a rare earth element;
Al: 0.00-1.00 wt %;
Cu: 0.12-0.50 wt %;
B: 0.85-1.10 wt %; and
a balance of Fe, wherein wt % refers to a weight percentage of respective elements in the raw material composition for the neodymium-iron-boron magnet material;
(2) a magnetic powder obtained after the pulverization has a particle size D50 of 3.8-4.2 μm;
the magnetic powder obtained after the pulverization has a particle size D90/D10 ratio which is ≤3.8; and
the magnetic powder obtained after the pulverization has an oxygen content≤300 ppm.

In the present invention, the composition formula of the raw material composition of the neodymium-iron-boron magnet material may be the same as the composition formula of the neodymium-iron-boron magnet material.

In the invention, the magnetic powder obtained after the pulverization preferably has a particle size D50 of 4.0-4.2 μm, such as 4.0 μm or 4.1 μm.

In the invention, the magnetic powder obtained after the pulverization has a particle size D90/D10 ratio which is preferably ≤3.7, such as 3.4, 3.5, 3.6 or 3.7.

In the present invention, the particle size of the magnetic powder obtained after the pulverization generally refers to the particle size of the magnetic powder after the pulverization and before the shaping.

In the present invention, if the particle size of the magnetic powder obtained after the pulverization is too small, local oxidation will easily occur during the subsequent pressing and sintering process, causing the proportion of Nd—O compounds to increase to 20% or more; if the particle size of the magnetic powder obtained after the pulverization is too large, although the proportion of the Nd—O phase having a FCC type crystal structure can be controlled within 20%, defects within the main phase particles will increase, resulting in a decrease in coercivity.

In the invention, the magnetic powder obtained after the pulverization has an oxygen content≤300 ppm, such as 150 ppm, 160 ppm, 170 ppm, 180 ppm, 190 ppm, 200 ppm, 220 ppm, 250 ppm, 280 ppm or 290 ppm.

In the present invention, the smelting process may be a conventional smelting process in this field.

Wherein, the vacuum degree for the smelting can be 5×10⁻² Pa (absolute pressure).

Wherein, the melting temperature can be 1550° C. or less, such as 1510° C.

In the present invention, the casting process may be a conventional casting process in this field.

Wherein, the casting process may adopt a rapid solidification casting method.

Wherein, the casting temperature can be 1390-1460° C., such as 1400° C.

Wherein, the thickness of the alloy casting sheet obtained after the casting can be 0.25-0.40 mm.

In the invention, the pulverization can be performed in a gas atmosphere with an oxidizing gas content of 100 ppm or less, for example, a gas atmosphere with an oxidizing gas content of 10 ppm, 20 ppm, 30 ppm, 50 ppm, 60 ppm or 70 ppm, wherein the oxidizing gas content refers to a mass percentage of oxygen or moisture in a gas of the gas atmosphere.

In the invention, the pulverization can comprise hydrogen decrepitation pulverization and jet mill pulverization.

Wherein, the hydrogen decrepitation pulverization generally comprises hydrogen absorption, dehydrogenation and cooling treatments in turn.

The hydrogen absorption can be carried out under the condition of hydrogen pressure of 0.085 MPa (absolute pressure).

The dehydrogenation can be carried out under a condition of evacuation and heating.

The dehydrogenation can be carried out at a temperature of 300-600° C., such as 500° C.

Wherein, the jet mill pulverization can be performed in a gas atmosphere with an oxidizing gas content of 100 ppm or less, for example, a gas atmosphere with an oxidizing gas content of 10 ppm, 20 ppm, 30 ppm, 50 ppm, 60 ppm or 70 ppm, wherein the oxidizing gas content refers to a mass percentage of oxygen or moisture in a gas of the gas atmosphere.

In the present invention, a lubricant, such as zinc stearate, can be added to the pulverized magnetic powder before shaping. The added amount of the lubricant can be 0.05-0.15%, such as 0.10%, of the mass of the pulverized magnet.

In the present invention, the molding may adopt a magnetic field shaping method.

Wherein, the magnetic field shaping can be performed under a magnetic field intensity of 1.8-2.5 T.

In the present invention, the sintering process may be a conventional sintering process in this field.

Wherein, the sintering temperature may be 1020-1100° C., such as 1085° C.

Wherein, the sintering time may be 4-8 h, such as 6 hours.

Wherein, the cooling after sintering can be performed in a protective atmosphere, for example, in an Ar gas atmosphere of 0.05 MPa (absolute pressure).

In the present invention, the aging treatment can be a conventional aging treatment in this field, which generally includes a primary aging treatment and a secondary aging treatment.

Wherein, the temperature of the primary aging treatment may be 800-1000° C., such as 900° C.

Wherein, the time of the primary aging treatment may be 2-6 hours, for example, 3 hours.

Wherein, the temperature of the secondary aging treatment may be 400-600° C., such as 480° C.

Wherein, the time of the secondary aging treatment may be 2-6 hours, such as 3.5 hours.

The invention further provides a neodymium-iron-boron magnet material prepared by the preparation method for a neodymium-iron-boron magnet material.

The invention further provides a neodymium-iron-boron magnet material, wherein a volume percentage of a Nd—O phase having a FCC type crystal structure in an intergranular triangular zone of the neodymium-iron-boron magnet material in a grain boundary phase of the neodymium-iron-boron magnet material is equal to or less than 20%; and
the grain boundary phase of the neodymium-iron-boron magnet material comprises a two-granule grain boundary phase and the intergranular triangular zone.

During the research and development process, the inventor creatively discovered that by controlling the proportion of the Nd—O phase having a FCC type crystal structure in the grain boundary phase within 20%, the obstruction of the Nd—O phase having the FCC type crystal structure with a higher melting point to the fluidity of the Nd-rich phase during the aging process is reduced, which is conducive to the formation of a continuous and uniform intergranular Nd-rich phase, thereby enhancing the demagnetizing coupling ability of the grain boundary phase and improving the consistency of the intrinsic coercivity of the magnet.

In the present invention, the oxygen content in the neodymium-iron-boron magnet material may be less than 600 ppm, such as 448 ppm, 455 ppm or 456 ppm.

In the present invention, the average grain size of the neodymium-iron-boron magnet material may be less than or equal to 7 μm, or may be 7.0-8.0 μm, such as 7.0 μm, 7.2 μm or 7.6 μm.

In the present invention, by controlling the proportion of the Nd—O phase having a FCC type Nd—O crystal structure within 20%, the average size of the crystal grains is effectively controlled, the volume ratio of the main phase in the magnet is increased, and the fluidity of the grain boundary phase during heat treatment is increased, thereby improving the remanence and coercivity of the magnet.

In the present invention, the volume proportion of the Nd—O phase having a FCC type crystal structure in the grain boundary phase is preferably ≤15.0%, such as 1.5%, 1.6%, 1.7%, 2.3%, 2.3%, 3.4%, 8.9%, 9.5%, 10.0%, 12.0% or 15.0%.

The invention further provides use of the neodymium-iron-boron magnet material as a raw material for preparing an electronic component.

In the present invention, the grain boundary phase may have the meaning conventionally understood in the art, and generally refers to the collective name for the area formed by the two-granule grain boundary phase and the intergranular triangular zone. The two-granule grain boundary phase is generally the grain boundary phase between two main phase particles. The intergranular triangular zone generally refers to an intergranular phase that is in direct contact with three or more main phase grains at the same time.

“D90/D10” mentioned in the present invention represents the concentration degree of particle distribution. In the industry relating to magnetic materials, the smaller the value of D90/D10, the better the concentration degree of the particle size distribution.

On the basis of common sense in the field, the above preferred conditions can be combined arbitrarily to obtain preferred examples of the present invention.

The reagents and raw materials used in the present invention are all commercially available.

The positive progressive effects of the present invention are as follows:
(1) According to the present invention, by controlling the compositions and manufacturing process, the formation of the Nd—O phase having an FCC type crystal structure is suppressed, and its volume percentage in the grain boundary phase is controlled within 20%. Thus, the obstruction of the Nd—O phase having the FCC type crystal structure with a higher melting point to the fluidity of the Nd-rich phase during the aging process is reduced, which is conducive to the formation of a continuous and uniform intergranular Nd-rich phase, thereby enhancing the demagnetizing coupling ability of the grain boundary phase and improving the consistency of the intrinsic coercivity of the magnet.
(2) The neodymium-iron-boron magnet material in the present invention has excellent properties, wherein: when Br≥13.65 kGs, the intrinsic coercivity is ≥16.4 kOe; the consistency is good, Hk/Hcj≥0.98; the mechanical properties are excellent, wherein the bending strength is ≥465 MPa.

### BRIEF DESCRIPTION OF THE DRAWINGS

FIG. 1 shows the TEM pattern of the neodymium-iron-boron magnet of Example 1, in which the black arrow indicates the Nd—O phase having a FCC type crystal structure.

FIG. 2 shows the transmission electron microscope diffraction spots of the neodymium-iron-boron magnet of Example 1, in which the bright spots represent the Nd—O phase having a FCC type crystal structure.

### DETAILED DESCRIPTION OF THE INVENTION

The present invention is further described below by means of examples, but the present invention is not limited to the scope of the described examples. Experimental methods that do not indicate specific conditions in the following examples should be selected according to conventional methods and conditions, or according to product specifications.

### Example 1

The raw materials were prepared according to the ingredients for a neodymium-iron-boron magnet material shown in Table 1 and the neodymium-iron-boron magnet material was prepared according to the following steps:
(1) Smelting: the prepared raw materials were put into a high-frequency vacuum induction smelting furnace with a vacuum degree of 5×10⁻² Pa (absolute pressure), and smelt into a molten liquid at a temperature of 1510° C.
(2) Casting: An alloy casting sheet was achieved by using rapid solidification casting method with a casting temperature of 1400° C. The thickness of the alloy casting sheet was 0.25-0.40 mm.
(3) Pulverization: The alloy casting sheet prepared in step (2) was subjected to hydrogen decrepitation pulverization and jet mill pulverization in turn.

The hydrogen decrepitation pulverization comprised hydrogen absorption, dehydrogenation and cooling treatment. Wherein, the hydrogen absorption was carried out under a hydrogen pressure of 0.085 MPa (absolute pressure); the dehydrogenation was carried out under the condition of evacuation while raising temperature; and the dehydrogenation temperature was 500° C.

The jet mill pulverization was performed with an oxidizing gas content of 100 ppm or less. The powder obtained by jet mill pulverization had a particle size D50 of 4.1 μm and D90/D10=0.37. The oxidizing gas content refers to the mass percentage of oxygen and/or moisture content in the gas for “jet mill pulverization”. The pressure in the grinding chamber of the jet mill pulverization was 0.70 MPa (absolute pressure). After the pulverization, a lubricant zinc stearate was added to the powder in an amount of 0.10% of the weight of the mixed powder.
(4) Magnetic field Shaping: Under a magnetic field strength of 1.8-2.5 T and the protection of a nitrogen atmosphere, the powder obtained by jet mill pulverization in step (3) was subjected to press shaping.
(5) Sintering: Under vacuum conditions of 5×10⁻³ Pa (absolute pressure), the pressed powder obtained in step (4) was sintered and cooled. Wherein, the sintering process conditions included: sintering at 1085° C. for 6 hours; and before cooling, Ar gas can be introduced to make the gas pressure reach 0.05 MPa (absolute pressure).
(6) Aging treatment: The sintered magnet material prepared in step (5) was sequentially subjected to a primary aging treatment and a secondary aging treatment, wherein the temperature for the primary aging was 900° C. and the time for the primary aging was 3 h; the temperature for the secondary aging was 480° C. and the time for the secondary aging was 3.5 h.

### Example 2-11 and Comparative Example 1-7

Raw materials were prepared according to the formulas shown in Table 1 below, wherein: the oxidizing gas content, the particle size D50, D90/D10, and oxygen content of the powder after jet mill pulverization in step (3) are shown in Table 2 below; the temperatures for the secondary aging in step (6) are shown in Table 2 below. Other preparation processes are the same as in Example 1.

TABLE 1

| | Ingredients/wt % | | | | | | | | | | |
|---|---|---|---|---|---|---|---|---|---|---|---|
| No. | Nd | Pr | Dy | Al | Cu | Ga | Co | Zr | Ti | B | Fe |
| Example 1 | 29.50 | / | / | 0.05 | 0.15 | 0.15 | 0.80 | 0.10 | / | 0.98 | Balance |
| Example 2 | 22.13 | 7.38 | / | 0.05 | 0.15 | 0.15 | 0.80 | 0.10 | 0.05 | 0.96 | Balance |
| Example 3 | 22.88 | 7.63 | 0.80 | 0.45 | 0.15 | 0.15 | 0.50 | 0.15 | / | 0.96 | Balance |
| Example 4 | 32.00 | / | / | 0.80 | 0.15 | 0.15 | 1.0 | 0.10 | 0.08 | 1.00 | Balance |
| Example 5 | 29.00 | / | 0.20 | 0.10 | 0.40 | 0.20 | 1.5 | 0.08 | 0.08 | 0.92 | Balance |
| Example 6 | 28.50 | / | 0.15 | 0.10 | 0.40 | 0.20 | 1.5 | 0.08 | 0.08 | 0.86 | Balance |
| Example 7 | 22.5 | 7.5 | 0.15 | 0.30 | 0.35 | 0.4 | 0.4 | 0.30 | / | 0.92 | Balance |
| Example 8 | 30.2 | / | / | 0.50 | 0.20 | 0.6 | 0.8 | 0.50 | / | 0.96 | Balance |
| Example 9 | 22.00 | 8.00 | 0.15 | / | 0.20 | 0.15 | 0.30 | 0.30 | / | 0.92 | Balance |
| Example 10 | 23.50 | 6.50 | 0.30 | / | 0.30 | 0.40 | 0.50 | 0.40 | / | 0.96 | Balance |
| Example 11 | 24.60 | 5.40 | 0.20 | / | 0.40 | 0.50 | 0.40 | 0.50 | / | 0.94 | Balance |
| Comparative Example 1 | 29.50 | / | / | 0.05 | 0.15 | 0.15 | 0.80 | 0.10 | / | 0.98 | Balance |
| Comparative Example 2 | 29.50 | / | / | 0.05 | 0.15 | 0.15 | 0.80 | 0.10 | / | 0.98 | Balance |
| Comparative Example 3 | 29.50 | / | / | 0.05 | 0.15 | 0.15 | 0.80 | 0.10 | / | 0.98 | Balance |
| Comparative Example 4 | 29.50 | / | / | 0.05 | 0.06 | 0.15 | 0.80 | 0.10 | / | 0.98 | Balance |
| Comparative Example 5 | 33.00 | / | / | 0.05 | 0.15 | 0.15 | 0.80 | 0.10 | / | 0.98 | Balance |
| Comparative Example 6 | 29.50 | / | / | 0.05 | 0.15 | 0.15 | 0.80 | 0.10 | / | 0.98 | Balance |
| Comparative Example 7 | 29.50 | / | / | 0.05 | 0.60 | 0.15 | 0.80 | 0.10 | / | 0.98 | Balance |

Note:
The proportion unit of respective elements in Table 1 is wt %, which represents the percentage of respective elements in the total mass of the neodymium-iron-boron magnet material.

TABLE 2

| | | | Oxidizing | Oxygen | Temperature |
|---|---|---|---|---|---|
| | | D90/ | Gas Content/ | Content of | for Secondary |
| No. | D50 | D10 | ppm | Powder/ppm | Aging/° C. |
| Example 1 | 4.1 | 3.7 | 20 | 150 | 480 |
| Example 2 | 4.1 | 3.6 | 10 | 180 | 490 |
| Example 3 | 4.0 | 3.5 | 10 | 220 | 480 |
| Example 4 | 4.1 | 3.5 | 20 | 200 | 480 |
| Example 5 | 4.1 | 3.4 | 10 | 160 | 480 |
| Example 6 | 4.1 | 3.5 | 30 | 250 | 480 |
| Example 7 | 4.0 | 3.5 | 50 | 280 | 490 |
| Example 8 | 4.0 | 3.6 | 60 | 290 | 480 |
| Example 9 | 4.1 | 3.5 | 10 | 170 | 490 |
| Example 10 | 4.0 | 3.6 | 20 | 190 | 480 |
| Example 11 | 4.0 | 3.5 | 70 | 290 | 480 |
| Comparative | 3.2 | 3.7 | 20 | 150 | 480 |
| Example 1 | | | | | |
| Comparative | 4.1 | 3.7 | 120 | 500 | 480 |
| Example 2 | | | | | |
| Comparative | 4.1 | 4.0 | 10 | 150 | 480 |
| Example 3 | | | | | |
| Comparative | 4.1 | 3.7 | 15 | 160 | 480 |
| Example 4 | | | | | |
| Comparative | 4.1 | 3.8 | 80 | 280 | 480 |
| Example 5 | | | | | |
| Comparative | 4.5 | 3.8 | 10 | 160 | 480 |
| Example 6 | | | | | |
| Comparative | 4.1 | 3.7 | 20 | 150 | 480 |
| Example 7 | | | | | |

Notes: In Table 3, the testing equipment used for powder particle size is the MS3000 Malvern laser particle size analyzer; the tester for powder oxygen content is HORIBA EMGA-830 oxygen, carbon and hydrogen combined analyzer; and the testing instrument used for oxidation gas content is the DH-2100 electrochemical trace oxygen analyzer.

### Effect Example 1

1. Determination of ingredients: The R-T-B magnets prepared in Examples 1-11 and Comparative Examples 1-7 were measured using a high-frequency inductively coupled plasma optical emission spectrometer (ICP-OES). The test results are shown in Table 3 below.

TABLE 3

| No. | Nd | Pr | Dy | Al | Cu | Ga | Co | Zr | Ti | B | Fe |
|---|---|---|---|---|---|---|---|---|---|---|---|
| Example 1 | 29.50 | / | / | 0.05 | 0.15 | 0.15 | 0.80 | 0.10 | / | 0.98 | Balance |
| Example 2 | 22.13 | 7.38 | | 0.05 | 0.15 | 0.15 | 0.80 | 0.10 | 0.05 | 0.96 | Balance |
| Example 3 | 22.88 | 7.63 | 0.80 | 0.45 | 0.15 | 0.15 | 0.50 | 0.15 | / | 0.96 | Balance |
| Example 4 | 32.00 | / | / | 0.80 | 0.15 | 0.15 | 1.0 | 0.10 | 0.08 | 1.00 | Balance |
| Example 5 | 29.00 | / | 0.20 | 0.10 | 0.40 | 0.20 | 1.5 | 0.08 | 0.08 | 0.92 | Balance |
| Example 6 | 28.50 | / | 0.15 | 0.10 | 0.40 | 0.20 | 1.5 | 0.08 | 0.08 | 0.86 | Balance |
| Example 7 | 22.5 | 7.5 | 0.15 | 0.30 | 0.35 | 0.4 | 0.4 | 0.30 | / | 0.92 | Balance |
| Example 8 | 30.2 | / | / | 0.50 | 0.20 | 0.6 | 0.8 | 0.50 | / | 0.96 | Balance |
| Example 9 | 22.00 | 8.00 | 0.15 | / | 0.20 | 0.15 | 0.30 | 0.30 | / | 0.92 | Balance |
| Example 10 | 23.50 | 6.50 | 0.30 | / | 0.30 | 0.40 | 0.50 | 0.40 | / | 0.96 | Balance |
| Example 11 | 24.60 | 5.40 | 0.20 | / | 0.40 | 0.50 | 0.40 | 0.50 | / | 0.94 | Balance |
| Comparative Example 1 | 29.50 | / | / | 0.05 | 0.15 | 0.15 | 0.80 | 0.10 | / | 0.98 | Balance |
| Comparative Example 2 | 29.50 | / | / | 0.05 | 0.15 | 0.15 | 0.80 | 0.10 | / | 0.98 | Balance |
| Comparative Example 3 | 29.50 | / | / | 0.05 | 0.15 | 0.15 | 0.80 | 0.10 | / | 0.98 | Balance |
| Comparative Example 4 | 29.50 | / | / | 0.05 | 0.06 | 0.15 | 0.80 | 0.10 | / | 0.98 | Balance |
| Comparative Example 5 | 33.00 | / | / | 0.05 | 0.15 | 0.15 | 0.80 | 0.10 | / | 0.98 | Balance |
| Comparative Example 6 | 29.50 | / | / | 0.05 | 0.15 | 0.15 | 0.80 | 0.10 | / | 0.98 | Balance |
| Comparative Example 7 | 29.50 | / | / | 0.05 | 0.60 | 0.15 | 0.80 | 0.10 | / | 0.98 | Balance |

Notes:
“/” means that the element is not added and not detected.

The values of the Fe contents in the neodymium-iron-boron magnet materials in the above Examples and Comparative Examples are obtained by subtracting the contents of respective elements from 100% a. Those skilled in the art know that the Fe content contains some inevitable impurities introduced during the preparation process.

### 2. Test for Magnetic Properties

By using the closed loop demagnetization curve testing equipment NIM-62000 manufactured by the China Institute of Metrology, the neodymium-iron-boron magnet materials obtained in Examples 1-11 and Comparative Examples 1-7 were tested for magnetic properties at a testing temperature of 20° C. to obtain the data on remanence (Br), intrinsic coercivity (Hcj), maximum magnetic energy product (BHmax) and squareness (Hk/Hcj). The testing results are shown in Table 4.

TABLE 4

| | Magnetic properties | | | | Bending |
|---|---|---|---|---|---|
| | Br | Hcj | BHmax | | strength |
| No. | (kGs) | (kOe) | (MGOe) | Hk/Hcj | (MPa) |
| Example 1 | 14.73 | 16.40 | 51.66 | 0.99 | 465 |
| Example 2 | 14.67 | 17.80 | 51.24 | 0.99 | 480 |
| Example 3 | 13.65 | 22.90 | 44.36 | 0.98 | 495 |
| Example 4 | 13.40 | 20.80 | 42.75 | 0.99 | 505 |
| Example 5 | 14.82 | 16.70 | 52.15 | 0.98 | 485 |
| Example 6 | 14.90 | 16.50 | 52.90 | 0.98 | 465 |
| Example 7 | 14.21 | 22.10 | 48.05 | 0.99 | 502 |
| Example 8 | 14.05 | 22.70 | 47.00 | 0.99 | 498 |
| Example 9 | 14.50 | 19.00 | 50.05 | 0.99 | 486 |
| Example 10 | 14.38 | 20.80 | 49.35 | 0.99 | 501 |
| Example 11 | 14.46 | 21.10 | 49.80 | 0.99 | 498 |
| Comparative | 14.61 | 16.40 | 50.82 | 0.85 | 280 |
| Example 1 | | | | | |
| Comparative | 14.67 | 15.90 | 51.24 | 0.92 | 302 |
| Example 2 | | | | | |
| Comparative | 14.63 | 15.40 | 50.96 | 0.90 | 256 |
| Example 3 | | | | | |
| Comparative | 14.73 | 14.90 | 51.66 | 0.97 | 230 |
| Example 4 | | | | | |
| Comparative | 13.85 | 16.90 | 46.56 | 0.95 | 290 |
| Example 5 | | | | | |
| Comparative | 14.75 | 15.30 | 51.80 | 0.94 | 150 |
| Example 6 | | | | | |
| Comparative | 14.71 | 15.8 | 51.45 | 0.93 | 210 |
| Example 7 | | | | | |

### 3. Characterization for Microstructure

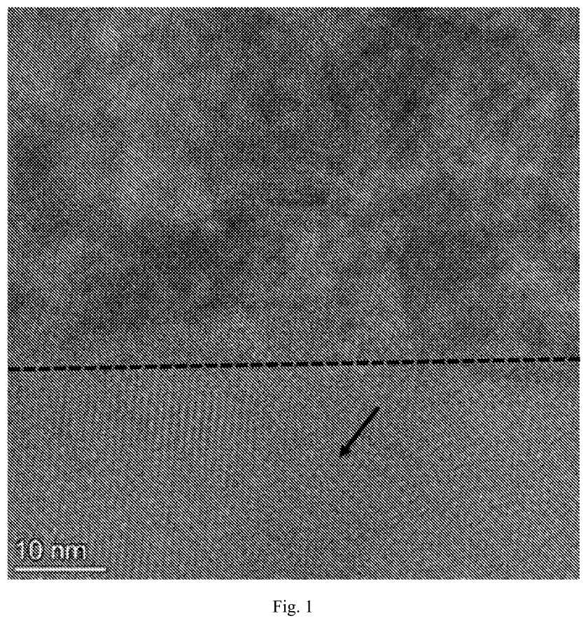

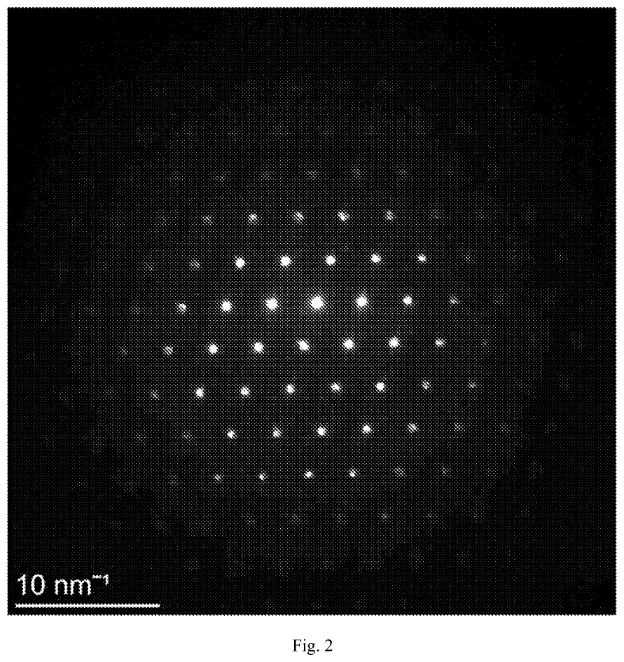

The neodymium-iron-boron magnet material prepared in Example 1 was subjected to TEM examination, and its microstructure is shown in FIG. 1. It can be seen from FIG. 1 that the percentage of the area of the Nd—O phase having a FCC type crystal structure in the total area of the Nd—O phase having a FCC type crystal structure and the intergranular Nd-rich phase in the cross section of the neodymium-iron-boron magnet material under testing (the aforementioned vertical orientation plane) is about 150 (the Nd—O phase with FCC type crystal structure is identified through transmission electron microscopy diffraction spots, as shown in FIG. 2; and further, the percentages of Nd—O phase were determined on the high-resolution spectrum).

TABLE 5

| | | Volume | | |
|---|---|---|---|---|
| | Volume Percentage | Percent- | | Average |
| | of Nd—O Phase | age of | Oxygen | Grain |
| | having FCC Type | Nd-rich | Content | Size of |
| | Crystal Structure | Phase | of Mag- | Mag- |
| No. | (%) | (%) | net(PPM) | net(μm) |
| Example 1 | 1.5 | 10.5 | 456 | 7.0 |
| Example 2 | 2.3 | 10.8 | 455 | 7.2 |
| Example 3 | 9.5 | 10.2 | 448 | 7.6 |
| Example 4 | 2.3 | 14.2 | 463 | 7.5 |
| Example 5 | 1.6 | 9.5 | 415 | 7.3 |
| Example 6 | 1.7 | 9.2 | 408 | 7.5 |
| Example 7 | 3.4 | 9.6 | 456 | 7.3 |
| Example 8 | 12.0 | 9.5 | 487 | 7.0 |
| Example 9 | 15.0 | 9.6 | 453 | 7.0 |
| Example 10 | 8.9 | 9.4 | 468 | 7.2 |
| Example 11 | 10.0 | 9.5 | 476 | 7.1 |
| Comparative | 25.0 | 11.3 | 1500 | 7.0 |
| Example 1 | | | | |
| Comparative | 22.0 | 11.1 | 750 | 7.0 |
| Example 2 | | | | |
| Comparative | 22.0 | 10.9 | 780 | 7.0 |
| Example 3 | | | | |
| Comparative | 15.0 | 9.8 | 590 | 7.0 |
| Example 4 | | | | |
| Comparative | 23.0 | 11.1 | 860 | 7.0 |
| Example 5 | | | | |
| Comparative | 16.0 | 10.3 | 530 | 10.0 |
| Example 6 | | | | |
| Comparative | 23.0 | 10.5 | 560 | 7.2 |
| Example 7 | | | | |

Notes: In Table 5, Volume Percentage of Nd—O Phase having FCC Type Crystal Structure refers to: the volume of the Nd—O phase having FCC type crystal structure/the volume of the grain boundary phase of the magnet*1000%; Volume Percentage of Nd-rich Phase refers to: the volume of the Nd-rich phase/the volume of the grain boundary phase of the magnet*100%; Average Grain Size of Magnet refers to the average grain size of the main phase grains; and the instrument used to measure the oxygen content of the magnet is the HORIBA EMGA-830 oxygen, carbon and hydrogen combined analyzer.

According to Table 4 and Table 5, the following conclusions can be drawn:
(1) The neodymium-iron-boron magnet materials obtained in Examples 1-11 has excellent performances, wherein: when Br≥13.65 kGs, the intrinsic intrinsic coercivity was ≥16.4 kOe; the consistency was superior, Hk/Hcj≥0.98; moreover, the Nd—O phase having FCC type crystal structure accountd for ≤15% in the grain boundary phase of the magnet; and the oxygen content of the neodymium-iron-boron magnet materials was low, and the average grain sizes were less than or equal to 7.6 μm.
(2) In Comparative Example 1, the D50 of the powder prepared after jet mill pulverization was is 3.2 μm, which was <3.8 μm; the volume percentage of the Nd—O phase with FCC type crystal structure in the grain boundary phase of the magnet exceeded 20%; and the magnet had higher oxygen content and poor magnetic properties.
(3) In Comparative Example 2, the oxygen content of the powder prepared after jet mill pulverization exceeded 300 ppm; the volume percentage of the Nd—O phase with FCC type crystal structure in the grain boundary phase of the magnet exceeded 20%; and the magnet had higher oxygen content and poor magnetic properties.
(4) In Comparative Example 3, the D90/D10 of the powder prepared after jet mill pulverization was 4.0, which was equal to or larger than 3.8; the volume percentage of the Nd—O phase with FCC type crystal structure in the grain boundary phase of the magnet exceeded 20%; and the magnet had higher oxygen content and poor magnetic properties.
(5) In Comparative Example 4, the Cu content in the neodymium-iron-boron magnet material was 0.06 wt %, which was equal to or less than 0.12 wt %; the magnet has low coercivity, poor consistency, and poor mechanical properties.
(6) In Comparative Example 5, RE was 33 wt %, and thus its rare earth element content was >32.00 wt %, which leaded to a reduction in its antioxidant capacity, which in turn leaded to the oxygen content of the magnet being≥600 ppm; and the magnet has low coercivity, poor consistency, and poor mechanical properties.
(7) In Comparative Example 6, the D50 of the powder prepared after jet mill pulverization was 4.5 μm, which was larger than 4.2 μm; the average particle size of the main phase grains in the magnet was 10 μm; and the magnet has low coercivity and poor mechanical properties.
(8) In Comparative Example 7, the Cu content in the neodymium-iron-boron magnet material was 0.5 wt %, which was larger than 0.40 wt %; the volume percentage of the Nd—O phase with FCC type crystal structure in the grain boundary phase of the magnet exceeded 20%; and the magnet has low coercivity, poor consistency, and poor mechanical properties.

1. A neodymium-iron-boron magnet material, comprising following components of:
R: 28.00-32.00 wt %, wherein the R is a rare earth element;
Al: 0.00-1.00 wt %;
Cu: 0.12-0.50 wt %;
B: 0.85-1.10 wt %; and
a balance of Fe, wherein wt % refers to a weight percentage of respective elements in the neodymium-iron-boron magnet material;
a volume percentage of a Nd—O phase having a FCC type crystal structure in an intergranular triangular zone of the neodymium-iron-boron magnet material in a grain boundary phase of the neodymium-iron-boron magnet material is equal to or less than 20%; and
the grain boundary phase of the neodymium-iron-boron magnet material comprises a two-granule grain boundary phase and the intergranular triangular zone.

2. The neodymium-iron-boron magnet material according to claim 1, wherein the neodymium-iron-boron magnet material satisfies one or more of the following conditions:
(1) the R has a content of 28.50-32.00 wt %;
(2) the R comprises a light rare earth element and/or a heavy rare earth element; the light rare earth element can be Pr and/or Nd;
the light rare earth element can have a content of 28.50-32.00 wt %;
the heavy rare earth element can be Dy and/or Tb;
the heavy rare earth element can have a content of 0.10-3.00 wt %;
(3) the Al has a content of 0.00-0.80 wt %;
(4) the Cu has a content of 0.13-0.50 wt %;
(5) the B has a content of 0.86-1.00 wt %;
(6) the neodymium-iron-boron magnet material further comprises one or more of Ga, Co, Zr and Ti;
(7) the volume percentage of the Nd—O phase having a FCC type crystal structure in a grain boundary phase of the neodymium-iron-boron magnet material is ≤15.0%;
(8) the grain boundary phase of the neodymium-iron-boron magnet material further comprises an Nd-rich phase;
wherein the volume percentage of the Nd-rich phase in the grain boundary phase of the neodymium-iron-boron magnet material is 9.0-15.0%;
(9) the neodymium-iron-boron magnet material has an oxygen content≤600 ppm; and
(10) the neodymium-iron-boron magnet material has a main phase average grain size of 7.0-8.0 μm.

3. The neodymium-iron-boron magnet material according to claim 2, wherein the neodymium-iron-boron magnet material satisfies one or more of the following conditions:
(1) when the R comprises Pr, the Pr has a content of 5.00-10.00 wt %;
(2) when the R comprises Nd, the Nd has a content of 20.00-32.00 wt %;
(3) when the R comprises Dy, the Dy has a content of 0.10-3.00 wt %;
(4) when the neodymium-iron-boron magnet material further comprises Ga, the Ga has a content of 0.00-1.00 wt %, excluding 0;
(5) when the neodymium-iron-boron magnet material further comprises Co, the Co has a content of 0.20-2.00 wt %;
(6) when the neodymium-iron-boron magnet material further comprises Zr, the Zr has a content of 0.05-0.60 wt %; and
(7) when the neodymium-iron-boron magnet material further comprises Ti, the Ti has a content of 0.05-0.40 wt %.

4. The neodymium-iron-boron magnet material according to claim 1, wherein:
the neodymium-iron-boron magnet material comprises following components of:
R: 28.00-32.00 wt %, wherein the R is a rare earth element;
Cu: 0.12-0.50 wt %;
B: 0.85-1.10 wt %;
Co: 0.20-2.00 wt %;
Ga: 0.05-0.80 wt %;
Zr: 0.05-0.60 wt %; and
a balance of Fe,
or
the neodymium-iron-boron magnet material comprises following components of:
Nd: 22.00-25.00 wt %;
Pr: 5.00-10.00 wt %;
RH: 0.10-1.00 wt %, wherein the RH comprises Dy and/or Tb;
Cu: 0.12-0.50 wt %;
B: 0.85-1.10 wt %;
Co: 0.20-2.00 wt %;
Ga: 0.15-0.60 wt %;
Zr: 0.05-0.50 wt %; and
a balance of Fe,
or
the neodymium-iron-boron magnet material comprises following components of:
R: 28.00-32.00 wt %, wherein the R is a rare earth element;
Cu: 0.12-0.50 wt %;
B: 0.85-1.10 wt %;
Al: 0.05-0.80 wt %;
Co: 0.20-2.00 wt %;
Ga: 0.05-0.80 wt %;
Zr: 0.05-0.60 wt %; and
a balance of Fe,
or
the neodymium-iron-boron magnet material comprises following components of:
Nd: 22.00-32.00 wt %;
Pr: 5.00-10.00 wt %;
RH: 0.10-1.00 wt %; wherein the RH comprises Dy and/or Tb;
Cu: 0.12-0.50 wt %;
B: 0.85-1.10 wt %;
Al: 0.05-0.80 wt %;
Co: 0.20-2.00 wt %;
Ga: 0.05-0.80 wt %;
Zr: 0.05-0.60 wt %;
Ti: 0.05-0.40 wt %; and
a balance of Fe.

5. A preparation method for a neodymium-iron-boron magnet material, comprising following steps of subjecting a raw material composition for the neodymium-iron-boron magnet material according to claim 1 to smelting, casting, pulverization, shaping, sintering and aging treatments in turn, wherein:
(1) the raw material composition for the neodymium-iron-boron magnet material comprises following components of:
R: 28.00-32.00 wt %, wherein the R is a rare earth element;
Al: 0.00-1.00 wt %;
Cu: 0.12-0.50 wt %;
B: 0.85-1.10 wt %; and
a balance of Fe, wherein wt % refers to a weight percentage of respective elements in the raw material composition for the neodymium-iron-boron magnet material;
(2) a magnetic powder obtained after the pulverization has a particle size D50 of 3.8-4.2 μm;
the magnetic powder obtained after the pulverization has a particle size D90/D10 ratio which is ≤3.8; and
the magnetic powder obtained after the pulverization has an oxygen content≤300 ppm.

6. The preparation method for a neodymium-iron-boron magnet material according to claim 5, wherein the preparation method for a neodymium-iron-boron magnet material satisfies one or more of the following conditions:
(1) the magnetic powder obtained after the pulverization has a particle size D50 of 4.0-4.2 μm;
(2) the magnetic powder obtained after the pulverization has a particle size D90/D10 ratio which is ≤3.7;
(3) the magnetic powder obtained after the pulverization has an oxygen content≤300 ppm;
(4) the pulverization is performed in a gas atmosphere with an oxidizing gas content of 100 ppm or less, wherein the oxidizing gas content refers to a mass percentage of oxygen or moisture in a gas of the gas atmosphere;
(5) the pulverization comprises hydrogen decrepitation pulverization and jet mill pulverization;
(6) the sintering is performed at a temperature of 1020-1100° C.;
(7) the sintering is performed for a time of 4-8 h; and
(8) the aging treatment comprises a primary aging treatment and a secondary aging treatment.

7. The preparation method for a neodymium-iron-boron magnet material according to claim 6, wherein the preparation method for a neodymium-iron-boron magnet material satisfies one or more of the following conditions:
(1) the hydrogen decrepitation pulverization comprises hydrogen absorption, dehydrogenation and cooling treatments in turn;
the hydrogen absorption can be carried out under a condition of hydrogen pressure 0.085 MPa;
the dehydrogenation can be carried out under a condition of evacuation and heating; the dehydrogenation can be carried out at a temperature of 300-600° C.;
(2) the jet mill pulverization is performed in a gas atmosphere with an oxidizing gas content of 100 ppm or less, wherein the oxidizing gas content refers to a mass percentage of oxygen or moisture in a gas of the gas atmosphere;
(3) the primary aging treatment is performed at a temperature of 800-1000° C.;
(4) the primary aging treatment is performed for a time of 2-6 h;
(5) the secondary aging treatment is performed at a temperature of 400-600° C.; and
(6) the secondary aging treatment is performed for a time of 2-6 h.

8. A neodymium-iron-boron magnet material prepared by the preparation method for a neodymium-iron-boron magnet material according to claim 5.

9. A neodymium-iron-boron magnet material, wherein a volume percentage of a Nd—O phase having a FCC type crystal structure in an intergranular triangular zone of the neodymium-iron-boron magnet material in a grain boundary phase of the neodymium-iron-boron magnet material is equal to or less than 20%; and
the grain boundary phase of the neodymium-iron-boron magnet material comprises a two-granule grain boundary phase and the intergranular triangular zone.

10. Use of the neodymium-iron-boron magnet material according to claim 1, 8 and 9 as a raw material for preparing an electronic component.
